(19) United States
(12) Patent Application Publication
(10) Pub. No.: US 2010/0301540 A1
(43) Pub. Date: Dec. 2, 2010

(54) CLAMPING MECHANISM

(75) Inventor: BING-JUN ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/634,678

(22) Filed: Dec. 9, 2009

(30) Foreign Application Priority Data
May 27, 2009 (CN) 200910302695.8

(51) Int. Cl. B25B 1/02

(52) U.S. Cl. 269/90

(57) ABSTRACT

A clamping mechanism includes a base, a clamping block, an operable post, and a locking unit. The base includes a fixing plate and a guiding rail. The clamping block is slidably mounted to the guiding rail and opposite to the fixing plate, to clamp an object cooperating with the fixing plate. The post is connected to the clamping block, to drive the clamping block to slide. The locking unit is used to lock the post.

### BACKGROUND

1. Technical Field

The present disclosure relates to a clamping mechanism for clamping an object.

2. Description of Related Art

An object, such as a heat sink for a central processing unit, needs to be clamped and released repeatedly during a manufacturing process or a test process. Generally, the object is clamped by a flat nose pliers, and the gad tong is used to clamp or release the object by operating a threaded rod. However, the threaded rod needs to be rotated many times to clamp or release the object, which is time consuming and inconvenient.

### BRIEF DESCRIPTION OF THE DRAWINGS

FIG. 1 is an assembled, isometric view of an embodiment of a clamping mechanism.

FIG. 2 is an assembled, isometric view of the clamping mechanism of FIG. 1 clamping an object.

FIG. 3 is an exploded, isometric view of the clamping mechanism of FIG. 1.

FIG. 4 is a cross-sectional view taken along the line IV-IV of the clamping mechanism of FIG. 1.

FIG. 5 is a cross-sectional view taken along the line V-V of the clamping mechanism and the object of FIG. 2.

### DETAILED DESCRIPTION

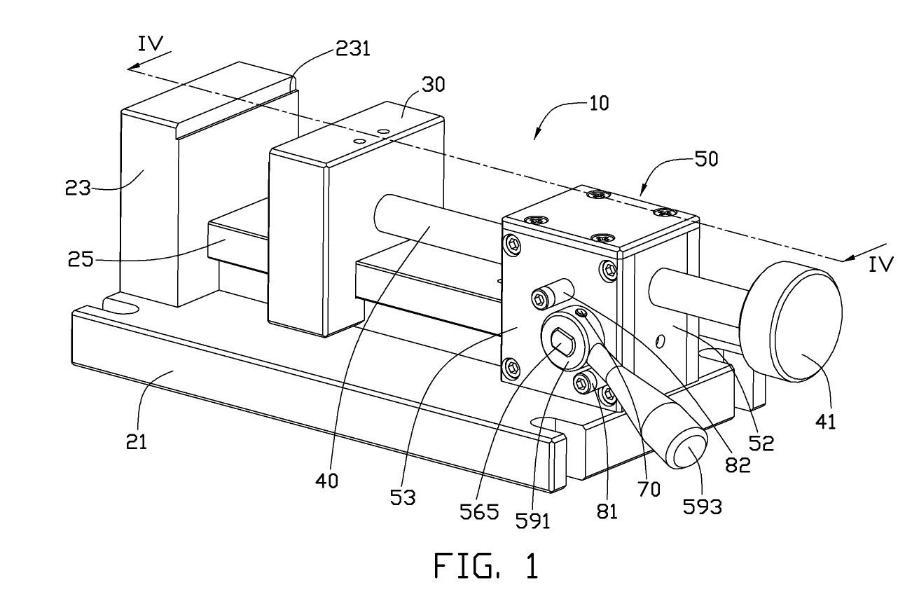

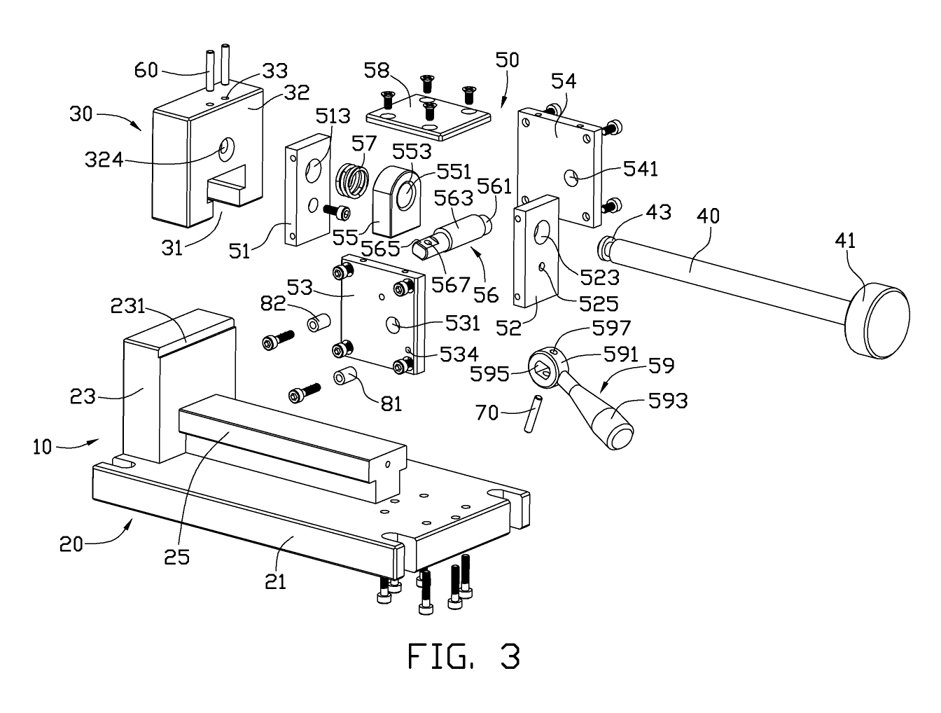

Referring to FIGS. 1 to 3, an embodiment of a clamping mechanism 10 is provided for clamping an object 90. The clamping mechanism 10 includes a base 20, a clamping block 30, a columnar post 40, and a locking unit 50. In this embodiment, the object 90 is a heat sink.

The base 20 includes a rectangular-shaped bottom plate 21, a fixing plate 23 perpendicularly formed on an end of the bottom plate 21, and an elongated guiding rail 25 formed on a middle part of the bottom plate 21. The guiding rail 25 has a T-shaped cross section, and extends along a longitudinal direction of the bottom plate 21. An end of the guiding rail 25 engages with the fixing plate 23. A positioning slot 231 is defined in a top of the fixing plate 23, facing the guiding rail 25.

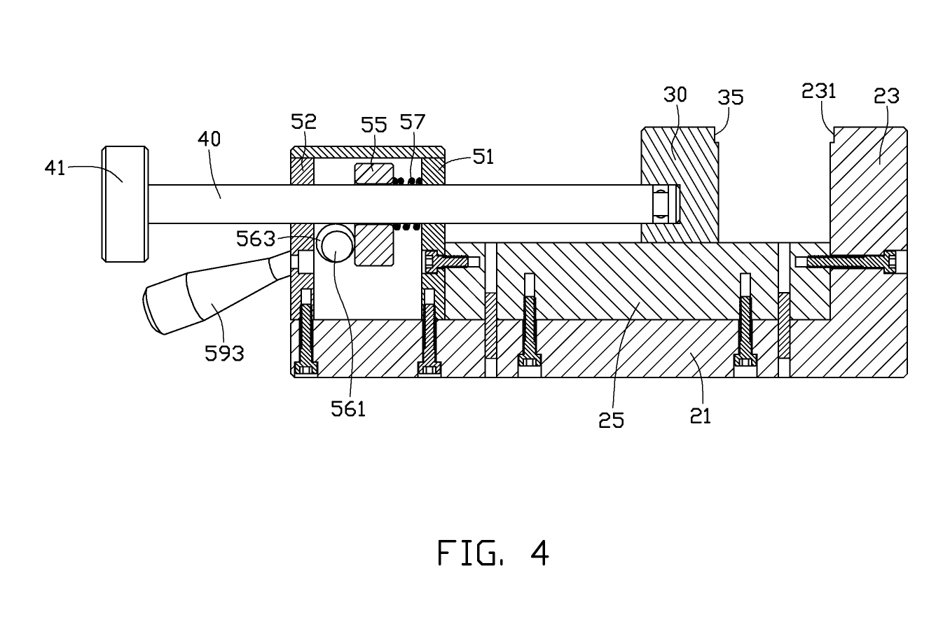

A T-shaped sliding slot 31 is defined in a bottom of the clamping block 30, with opposite ends of the sliding slot 31 extending through opposite sides 32 of the clamping block 30, respectively. A blind hole 324 is defined in a middle of one of the sides 32, and a positioning slot 35 (as shown in FIG. 4) is defined in a top of the other one of the sides 32, facing the positioning slot 231. Two spaced fixing holes 33 are defined in a top of the clamping block 30, communicating with the blind hole 324.

An operating portion 41 protrudes from a first end of the post 40, and a circular-shaped groove 43 is defined in a circumference of the post 40, adjacent to a second end opposite to the first end.

The locking unit 50 includes a first stop plate 51, a second stop plate 52, a first supporting plate 53, a second supporting plate 54, a self-locking block 55, an eccentric shaft 56, an elastic member 57, a cover 58, and a locking handle 59. The first stop plate 51 defines a through hole 513. The second stop plate 52 defines a through hole 523 corresponding to the through hole 513 of the first stop plate 51, and a bore 525. The first supporting plate 53 defines two positioning holes 534, and a pivot hole 531 between the positioning holes 534. The second supporting plate 54 defines a pivot hole 541 corresponding to the pivot hole 531 of the first supporting plate 53. A locking hole 551 is defined in a middle of the self-locking block 55. Opposite ends of the locking hole 551 correspondingly extend through opposite sidewalls of the self-locking block 55, and a circular-shaped chamfer 553 is formed on each sidewall of the self-locking block 55 bounding the corresponding end of the locking hole 551. The locking hole 551 has a dimension forming a clearance fit with the post 40. The eccentric shaft 56 includes a shaft 561, and a columnar eccentric portion 563 protruding from a middle of a circumference of the shaft 561. An axis of the eccentric portion 563 is deviated from an axis of the shaft 561. The circumference of the shaft 561 adjoining an end of the shaft 561 is cut to form a fixing portion 565 with opposite planes. A latching hole 567 is defined in the fixing portion 565 through the opposite planes. The elastic member 57 is a compression spring. The locking handle 59 includes a latching portion 591, and a hand grip 593 extending from the latching portion 591. The latching portion 591 defines a fixing slot 595, and a through slot 597 communicating with the fixing slot 595.

Referring to FIGS. 1 and 4, in assembly, the sliding slot 31 of the clamping block 30 is engaged with a distal end of the guiding rail 25 away from the fixing plate 23 of the base 20, with the positioning slot 35 of the clamping block 30 facing the positioning slot 231 of the fixing plate 23. The clamping block 30 is pushed to slide towards the fixing plate 23 along the guiding rail 25. The first and second stop plates 51 and 52 are fixed to the bottom plate 21 of the base 20 in parallel via screws, with the first stop plate 51 resisting the distal end of the guiding rail 25, and the through holes 513 and 523 of the first and second stop plates 51 and 52 aligning with the blind hole 324 of the clamping block 30. A screw is provided to fix the first stop plate 51 to the guiding rail 25. The second end of the post 40 extends through the through hole 523 of the second stop plate 52, the locking hole 551 of the self-locking block 55, the elastic member 57, and the through hole 513 of the first stop plate 51, and then is inserted into the blind hole 324 of the clamping block 30. Two pins 60 are provided to extend through the fixing holes 33 of the clamping block 30 and engage in the groove 43 and at opposite sides of the post 40, to sandwich the post 40. Thereby, the post 40 is locked to the clamping block 30. The first supporting plate 53 is fixed to the bottom plate 21 of the base 20 via screws, and perpendicularly connected to corresponding sides of the first and second stop plates 51 and 52 via screws. The eccentric shaft 56 is arranged between the second stop plate 52 and the self-locking block 55. The fixing portion 565 of the eccentric shaft 56 extends through the pivot hole 531 of the first supporting plate 53, and is inserted into the fixing slot 595 of the locking handle 59. A pin 70 is provided to be inserted into the through slot 597 of the locking handle 59 and the latching hole 567 of the fixing portion 565, to fix the fixing portion 565 of the eccentric shaft 56 to the locking handle 59. Thereby, the locking handle 59 is pivotally arranged at an outside of the first supporting plate 53. Two screws are provided to correspondingly extend through a first resisting pole 81 and a second resisting pole 82, and engage in the positioning holes 534 of the first supporting plate 53. Thereby, the first and second resisting poles 81 and 82 are located at opposite sides of the hand grip 593 of the locking handle 59, to restrict the hand grip 593 to rotating between the first and second resisting poles 81 and 82. The second supporting plate 54 is perpendicularly fixed to opposite sides of the first and second stop plates 51 and 52 via screws, allowing the pivot hole 541 of the second supporting plate 54 to align with the pivot hole 531 of the first supporting plate 53. An opposite end of the shaft 561 away from the fixing portion 565 of the eccentric shaft 56 is inserted into the pivot hole 541 of the second supporting plate 54. Opposite ends of the self-locking block 55 correspondingly engage with the first and second supporting plates 53 and 54. The cover 58 is fixed to tops of the first and second stop plates 51 and 52 and the first and second supporting plates 53 and 54, for preventing the penetration of dust. Thereby, the clamping mechanism 10 is assembled. At this time, the hand grip 593 of the locking handle 59 abuts the first resisting pole 81, and a less eccentric section of the eccentric portion 563, which is nearer to the axis of the shaft 561 of the eccentric shaft 56 and engages with a lower portion of the self-locking block 55. The clamping mechanism 10 is unlocked. The post 40 is operable to drive the clamping block 30 to slide along the guiding rail 25. An operator can oil the post 40, the self-locking block 55, and the eccentric shaft 56 through the bore 525 of the second stop plate 52.

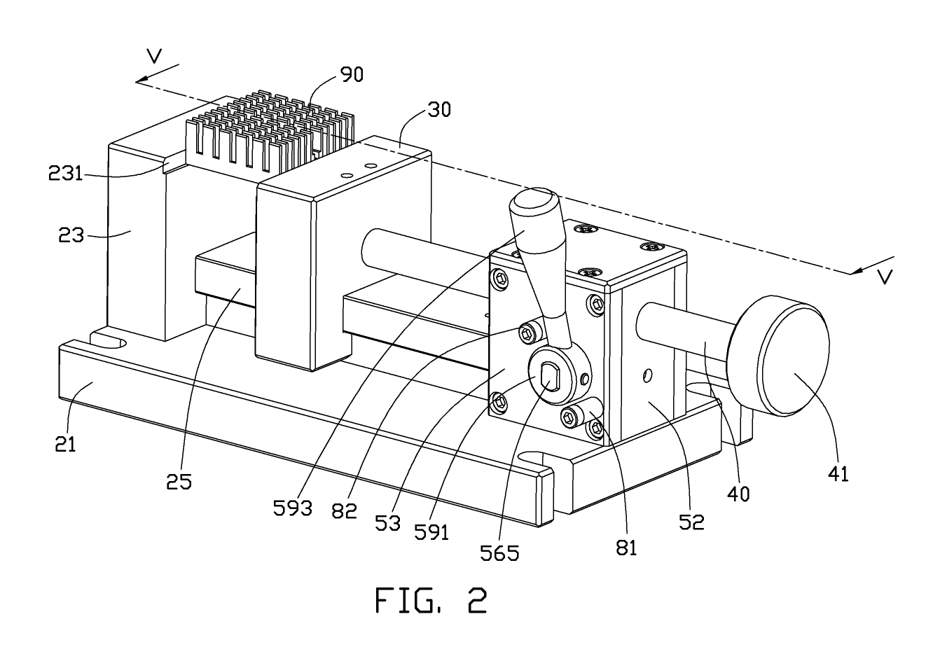

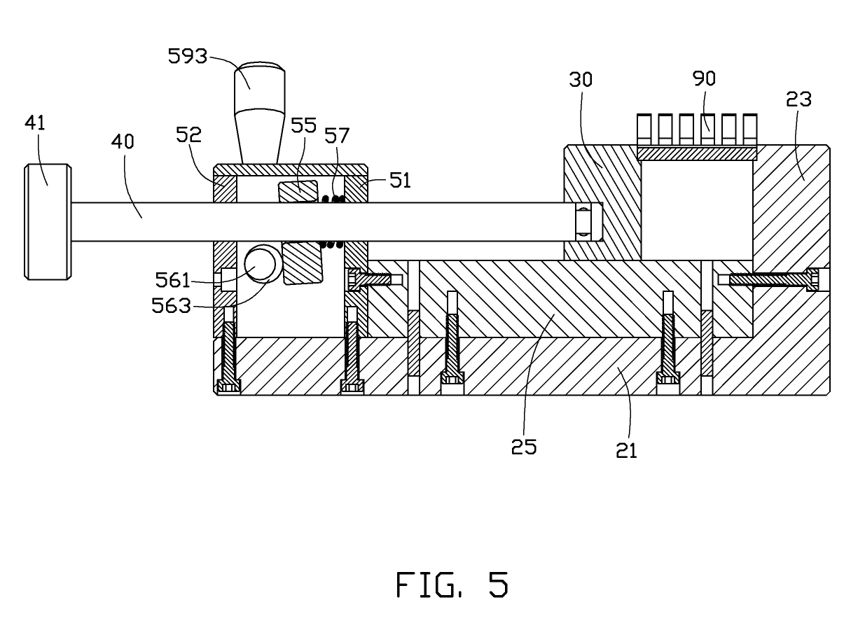

Referring to the FIGS. 2 and 5, to clamp the object 90, the post 40 of the clamping mechanism 10 is pushed or pulled to drive the clamping block 30 to slide towards or far away from the fixing plate 23, until the distance between the fixing plate 23 and the clamping block 30 is a little greater than a width of the object 90. The object 90 is placed on bottoms of the positioning slots 231 and 35 of the fixing plate 23 and the clamping block 30. The post 40 is pushed towards the fixing plate 23, until the object 90 is firmly sandwiched between the fixing plate 23 and the clamping block 30. The hand grip 593 of the locking handle 59 is rotated towards the second resisting pole 82, to drive the eccentric shaft 56 to rotate. A maximum eccentric section of the eccentric portion 563, which is farthest away from the axis of the shaft 561 of the eccentric shaft 56, is rotated towards the self-locking block 55, and pushes the lower portion of the self-locking block 55 to rotate towards the first stop plate 51 and compress the elastic member 57. A top portion of the self-locking block 55 is rotated towards the second stop plate 52. The circular-shaped chamfers 553 and an inner surface bounding the locking hole 551 of the self-locking block 55 engage with top and bottom sides of the post 40, to produce self-locking friction on the post 40 and push the post 40 to move a little together with the clamping block 30 towards the fixing plate 23. Thereby, the object 90 is further clamped by the clamping block 30 and the fixing plate 23. When the hand grip 593 of the locking handle 59 is rotated to abut the second resisting pole 82, the maximum eccentric section of the eccentric portion 563 of the eccentric shaft 56 engages with the self-locking block 55, the self-locking friction between the self-locking block 55 and the post 40 is large enough to lock the post 40 to the self-locking block 55. Thereby, the clamping mechanism 10 is locked, and the object 90 is firmly clamped.

To release the object 90, the hand grip 593 of the locking handle 59 is rotated towards the first resisting pole 81, allowing the maximum eccentric section of the eccentric portion 563 of the eccentric shaft 56 to rotate away from the self-locking block 55. The elastic member 57 is restored to push the lower portion of the self-locking block 55, and allow the self-locking block 55 to be rotated to a vertical position. The self-locking friction between the self-locking block 55 and the post 40 gradually disappears. The post 40 is pulled to drive the clamping block 30 to slide away from the fixing plate 23. Thereby, the object 90 is released.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A clamping mechanism, comprising:
a base comprising a fixing plate and a guiding rail;
a clamping block slidably mounted to the guiding rail and opposite to the fixing plate, to clamp an object cooperating with the fixing plate;
a post connected to the clamping block; and
a locking unit comprising:
a first stop plate fixed to the base to support the post;
a self-locking block placed around the post;
an elastic member sandwiched between the first stop plate and the self-locking block;
opposite first and second supporting plates fixed to the base;
an eccentric shaft comprising an eccentric portion, the eccentric shaft pivotally connected between the first and second supporting plates and positioned one side of the self-locking block opposite to the elastic member, and an end of the eccentric shaft extending through the first supporting plate and exposed out of the first supporting plate; and
a locking handle connected to the end of the eccentric shaft exposed out of the first supporting plate;
wherein when the locking handle is rotated, the eccentric shaft is rotated to allow the eccentric portion to push the self-locking block, the self-locking block is pushed to rotate relative to the post, and self-locking friction is produced between the self-locking block and the post to lock the self-locking block to the post.

2. The clamping mechanism of claim 1, wherein the fixing plate is arranged at a first end of the guiding rail, and the first stop plate is arranged at a second end of the guiding rail opposite to the first end, the first stop plate is perpendicularly connected between corresponding ends of the first and second supporting plates adjacent to the fixing plate.

3. The clamping mechanism of claim 2, wherein the locking unit further comprises a second stop plate opposite to the first stop plate and connected between opposite ends of the first and second supporting plates away from the fixing plate, each of the first and second supporting plates defines a though hole to allow the post to extend therethrough.

4. The clamping mechanism of claim 3, wherein the eccentric shaft is arranged between the self-locking block and the second stop plate, when the locking handle is rotated, the eccentric shaft pushes a portion of the self-locking block towards the first stop plate, allowing the self-locking block to rotate relative to the post.

5. The clamping mechanism of claim 1, wherein the locking handle comprises a latching portion connected to the eccentric shaft, and a hand grip extending from the latching portion.

6. The clamping mechanism of claim 5, wherein a first resisting pole and a second resisting pole are located at an outside of the first supporting plate opposite to the second supporting plate, the hand grip of the locking handle is restricted to rotate between the first and second resisting poles, when the hand grip of the locking handle is rotated to abut the second resisting pole, a maximum eccentric section of the eccentric portion of the eccentric shaft is rotated to engage with the self-locking block.

7. The clamping mechanism of claim 5, wherein a circumference of the end of the eccentric shaft exposed out of the first supporting plate is cut to form a fixing portion with opposite planes, a latching hole is defined in the fixing portion through the opposite planes, the latching portion of the locking handle defines a fixing slot receiving the fixing portion, and a through slot communicating with the fixing slot and aligning with the latching hole of the eccentric shaft, a pin is inserted into the through hole and the latching hole, to fix the locking handle to the eccentric shaft.

8. The clamping mechanism of claim 1, wherein the eccentric shaft further comprises a shaft, opposite ends of the shaft are correspondingly pivotally connected to the first and second supporting plates, the eccentric portion is columnar and protrudes from a middle of a circumference of the shaft, an axis of the eccentric portion is deviated from an axis of the shaft.

9. The clamping mechanism of claim 1, wherein a locking hole is defined in the self-locking block through opposite sidewalls of the self-locking block to receive the post, a circular chamfer is formed on each of the sidewalls of the self-locking block bounding a corresponding end of the locking hole, the locking hole has a dimension forming a clearance fit with the post, when the self-locking block is pushed to rotate relative to the post, the circular chamfers and an inner surface bounding the locking hole of the self-locking block engage with opposite sides of the post to produce the self-locking friction.

10. The clamping mechanism of claim 1, wherein the elastic member is placed around the post.

11. The clamping mechanism of claim 1, an operating portion is formed on an end of the post away from the clamping block.

12. The clamping mechanism of claim 1, wherein a circular-shaped groove is defined in an end of the post connected to the clamping block, a blind hole is defined a side of the clamping block facing the post, two spaced fixing holes are defined in a top of the clamping block communicating with the blind hole, the end of the post defining the circular-shaped groove is inserted into the blind hole, two pins extend through the fixing holes of the clamping block and engage in the groove to sandwich the post and connect the post to the clamping block.

13. The clamping mechanism of claim 1, wherein a positioning slot is defined in a top of each of fixing plate and the clamping block, and the positioning slots of the fixing plate and the clamping block face each other.
